(19) United States
(12) Patent Application Publication
(10) Pub. No.: US 2009/0313325 A1
(43) Pub. Date: Dec. 17, 2009

(54) Distributed Technique for Cascaded Data Aggregation in Parallel Fashion

(75) Inventors: George Vanecek, Madison, WI (US); John Waclawsky, Bartlett, IL (US); Nino Vidovic, Saratoga, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: MOBILE TRIBE LLC, Redwood City, CA (US)

(21) Appl. No.: 12/485,688

(22) Filed: Jun. 16, 2009

Related U.S. Application Data
(60) Provisional application No. 61/073,345, filed on Jun. 17, 2008.

(51) Int. Cl. G06F 15/16

(52) U.S. Cl. 709/203; 709/206; 709/204

(57) ABSTRACT

Methods and apparatus are provided that access and present information associated with dynamic communities in an efficient and highly scalable manner. Dynamic communities are formed based on a trigger, which may be a command, a request for information, or an event notification. An apparatus may receive notification of the trigger and form a dynamic community from one or more data sources, such as social-networking websites and enterprise data sources. Sub-triggers may be generated based on the trigger and the dynamic community. The sub-triggers may be sent from the apparatus. A result may then be generated based on received responses to the sub-triggers.

### RELATED APPLICATIONS

The present application claims priority to U.S. Provisional Patent Application No. 61/073,345, filed on Jun. 17, 2008, entitled “A Distributed Technique for Cascaded Data Aggregation in Parallel Fashion,” the entire contents of which are hereby incorporated by reference herein.

### FIELD OF THE INVENTION

This invention generally relates to information processing, and particularly relates to providing information associated with dynamic communities.

### BACKGROUND

As networked computers have become more widespread, people and organizations (e.g., businesses, non-profit organizations, and government offices) have found social uses for computers. Many social uses are associated with social-networking websites as well as many on-the-job activities. These social uses now include sharing of most, if not all, types of information that can be shared out electronically. Example social-networking websites include Yahoo!, Facebook, Twitter, MySpace, and YouTube.

Each of the social-networking websites permits individuals and/or organizations to register as users of the social-networking website. Once registered, the user may be permitted to enjoy use of various services, such as e-mail, blogging, picture and video sharing, and sending of short messages. Many social-networking websites have one or more specialties that attract visitors to the website; for example, YouTube specializes in video sharing.

Additionally, many people have access to computers at work. Frequently, business activities, such as meetings, conference calls, workshops, and lectures, involve both social and electronic-communication aspects as well. One common example is an electronic meeting notice e-mailed or otherwise electronically disseminated to all persons invited to a meeting or conference call.

As the use of social-networking websites expands, social and other information related to events, topics, and/or people is divided among social-networking websites and/or work-related computers. Coordination of this information often requires manually accessing each website/computer and then inputting the data retrieved from each website/computer into a common document (e.g., a text file or spreadsheet) or application (e.g., a database). This manual coordination process may be require considerable time to performing the multiple searches manually and error-prone during the transfer of data from the websites to the common document or application.

### SUMMARY

A first embodiment provides a method. A request is received at an MT server. The request includes a dynamic-community definition and a requested operation. The MTserver divided the request into a first plurality of sub-requests based on the dynamic-community definition. The MTserver sends each of the first plurality of sub-requests. The MTserver receives a first plurality of responses. Each response in the first plurality of responses is based on at least one of the first plurality of sub-requests. The MTserver generates a result to the request. The result is based on the first plurality of received response. The MTserver sends the result.

A second embodiment provides a method. An MTserver receives an event indication. The MTserver screens the event indication according to one or more policies. The MTserver forms a dynamic community at the MTserver based on the screened event indication. The MTserver generates a response based on the screened event indication. The MTserver sends the response to one or more members of the dynamic community.

A third embodiment provides an apparatus. The apparatus includes a processing unit, data storage, and machine-language instructions stored in the data storage. The machine-language instructions are executable by the processing unit to perform functions. The functions include: (a) receiving a trigger, (b) determining a dynamic community based on the trigger, (c) generating one or more sub-triggers based on the trigger and the dynamic community, and (d) sending each of the one or more sub-triggers.

### BRIEF DESCRIPTION OF THE DRAWINGS

Various examples of embodiments are described herein with reference to the following drawings, wherein like numerals denote like entities, in which:

FIG. 1 is an example communications network, in accordance with embodiments of the invention;

FIG. 2A depicts a scenario of authenticating an MTclient, in accordance with embodiments of the invention;

FIG. 2B depicts a scenario of a pull operation by requesting contact information, in accordance with embodiments of the invention;

FIG. 3 depicts a scenario involving a location event, in accordance with embodiments of the invention;

FIG. 4 depicts an example computing device, in accordance with embodiments of the invention;

FIG. 5 is a flowchart depicting an example method, in accordance with embodiments of the invention;

FIG. 6 is a flowchart depicting an example method, in accordance with embodiments of the invention; and

FIG. 7 is a flowchart depicting an example method, in accordance with embodiments of the invention.

### DETAILED DESCRIPTION

This invention is related to the formation and use of dynamic communities to aggregate information divided among various websites and data repositories. Each dynamic community can include a number of data sources, such as social-networking websites and work-related computers. Upon receipt of a trigger, (e.g., a request, command, or event notification), some or all of the data sources in the dynamic community may be searched for data relevant to the trigger. The relevant data may then aggregated into an aggregate data item. The aggregate data item may then be displayed or formatted in user-friendly fashion, such as a mash-up, or as requested.

As the use of social-networking websites expands, social and other information related to events, topics, and/or people is divided among social-networking websites and/or work-related computers. Coordination of this information often requires manually accessing each website/computer and then inputting the data retrieved from each website/computer into a common document (e.g., a text file or spreadsheet) or application (e.g., a database). This manual coordination process may require considerable time to performing the multiple searches manually and error-prone during the transfer of data from the websites to the common document or application.

Dynamic communities may be formed at one or more servers, each server herein named an “MTserver”, based on a “trigger”. The trigger may be a command, a request for information or an “event indication” related to an external activity. Example event indications include an indication a person has changed location (e.g., a notification that Elvis has left the building), occurrence of a news event (e.g., a tornado has touched down near Plainfield, Ill.), receipt of an e-mail message, or posting of a blog entry. Dynamic communities may also be related to “operations” applied to one or more “data sources”. Example operations include sending a message, searching for requested information, or retrieving contact information. In some contexts, the triggers may be divided into “pull” operations that bring data to a user upon request of the user (that is, the user “pulled” the data in by request) and “push” operations that bring data to the user without a request (that is; the data is “pushed” onto the user). Example data sources include social-networking websites, other websites, work-related websites, and other data repositories.

For example, suppose Jane Doe, a resident of Los Angeles, wants to invite all of her friends currently in town to a party. Jane may send a command to an MTserver to send the party invitation to all of her contacts stored at several social-networking websites in Los Angeles. The MTserver may then form a dynamic community of all Jane's contacts, filter the contacts based on Jane's location criteria, and then send the party invitation to the filtered set of contacts. The filtering of location criteria would be determined based on the results of previous events indicating the locations of each of Jane's contacts. Further, Jane may send a command to the MTserver to inform her of electronic messages (e.g., e-mail, SMS, electronic invitation responses, etc.) received from these contacts. The MTserver may handle each received message as an event, and create a dynamic community for Jane (and perhaps the sender of the received message), and then a notification of the event to the dynamic community.

Once the dynamic community is formed, information stored in the dynamic community may be “aggregated” by the MTserver. Aggregation of data may involve (a) retrieval of data from some or all of the data sources in the dynamic community related to the trigger and/or the operation(s), (b) “filtering” the retrieved data, and then (c) presenting the filtered data.

For example, if the trigger is a request to generate a list of all contacts from three social-networking websites and work-related computer, the MTserver may retrieve the requested contacts by subdividing the request into four sub-requests (one for each data source). Each sub-request may involve performing a “get contact list” operation from the indicated website.

Once the sub-requests have been executed, the retrieved data may be correlated and/or filtered by the MTserver. Data correlation may involve formation of one or more “aggregate data items.” For example, suppose multiple copies of a contact were retrieved, each with different information so as not to be duplicates (e.g., a first contact for J.Q. Public may have a work number of 123-4567 and email address of j.q.public@work.com and a second contact for J.Q. Public may have an email address of jqp1@SocialNetwork.com). The aggregate data item may be formed by common fields of related data items; in the J.Q. Public example, the aggregate data item may be a “contact” with a “name” of J.Q. Public, “e-mail addresses” of j.q.public@work.com and jqp@SocialNetwork.com, and a “phone number” of 123-4567. The data may then be correlated by replacing the original data items used to form the aggregate data item with the aggregate data item. Filtering may involve data reduction. Data reduction may involve a number of techniques. For example, if two exact copies of a contact with the same e-mail address in both copies are retrieved from two different data sources, a duplicate copy may be removed. Optionally, data compression techniques can be applied after correlation and/or filtering to further reduce the size of data being returned. Example data compression techniques include lossless compression techniques, lossy compression techniques, run-length encoding, Lempel-Ziv coding, Lempel-Ziv-Welch coding, Huffman coding, arithmetic-coding-based compression, JBIG compression, inverse-arithmetic coding. Many other data compression techniques may also or instead be applied as well.

In some cases, the sub-request may be received by one or more MTservers. A second MTserver receiving the sub-request may in turn determine, using similar techniques to those described above, that satisfying the sub-request requires aggregation; that is, the sub-request may be in turn sub-divided and the resulting data correlated and/or filtered to generate a result. This aggregation process of sub-dividing requests, receiving data, and then correlating and/or filtering data, may be repeated as needed to satisfy the original request.

Once the retrieved data has been correlated and/or filtered, a result may be generated that includes the correlated and/or filtered data. The result may then be presented to one or more users associated with the dynamic community. The result may be presented as a “mash-up” or other aggregation of data (e.g., a table, list, or a spreadsheet). For example, a list of locations of friends may be presented as a mash-up with a map and indications of each friend's location on the map. Many other examples of mash-ups are possible as well. Other results may be displayed simply; a requested article may be simply displayed on a screen. More generally, results may be audio, visual, textual, and/or binary data, and may be displayed, played or otherwise presented using a variety of techniques. The result may be formatted using a variety of techniques, such as a result formatted as an eXtended Markup Language (XML) document, as a web page, as a graphical object, as a text document, an audio file, video file, or still image file, or using other similar techniques.

The MTserver may autonomously and constantly monitor for pre-determined state changes. This monitoring capability has the advantage of dynamically triggering data collection and delivering pre-determined service request data in response to state changes (or events—such as a meeting date) in a social network or upon the formation of long-lived or short-lived dynamic communities.

Parallel and decentralized processing allows for the aggregation, correlation, filtering, organization, and presentation of content at any point in a network; thus providing for a great deal of scalability. The scalability is based upon the ability to leverage multiple distributed processors for parallel data collection and correlation. This scalability is of significant value in social communities where service requests for information can range from a simple service request for a phone number or an IP address to a complex assembly of multiple data sources (like complex queries in data base) needed to address broad information service requests (such as tell me everything about my favorite movie star, all hotels in an area, restaurants in a geographic location etc). Additionally, the use of parallel and distributed processing permits scalability of communications; that is, multiple communication channels may be employed simultaneously for faster connectivity speeds and reporting of results to users of MTservers. Parallel processing in the creation of dynamic communities and rendering services may be used to respond to queries and events that require access to dispersed data sources.

The use of a number of MTservers permits for controlled access to public and private data. For example, some MTservers in a network may be publically accessible via the Internet or other public data network. Other MTservers may be used by an enterprise with various controls on the publication of the organization's data, such as the use of firewalls, access policies, encrypted or password-protected data. Many other examples of access controls are possible as well. MTservers within such enterprises may filter requested data and/or provide results based on these access policies. MTservers may also perform dual roles; for example, an MTserver at an enterprise may provide access to some data publically (e.g., press releases, required financial reports, product information) and some privately based on the access controls.

Information relevant to the newly formed social community is subject to “late binding”; that is information is not collected until the community is instantiated. Late binding allows improved scalability since information requests are not processed until they are needed. Late binding further has the advantage of provide current information in response to queries.

A collection of MTservers, MTproxies, and MTclients as described herein may be used to form an overlay network. The overlay network may be instantiated on a wide variety of physical and logical networks. Service processing within the overlay network may be tightly controlled by a single MTserver or otherwise restrict access to and data provide by MTservers. In other overly networks, decentralized control may be provided by use of distributed MTservers provided by cooperating network locations.

The use of overlay network may provide other advantages as well. Overlay networks may facilitate caching and service request history collection for diagnostic and capacity planning information. An overlay network can use a dynamic hierarchy of processes that relate to a structure of a physical network to better coordinate requests over the physical network. Service requests in the overlay network can be dynamically controlled and adjusted (via programming) at any MTserver to respond to network conditions, such as use of alternate/backup server(s) due to a connectivity break, for load distribution, and/or load balancing.

An Example Communication Network

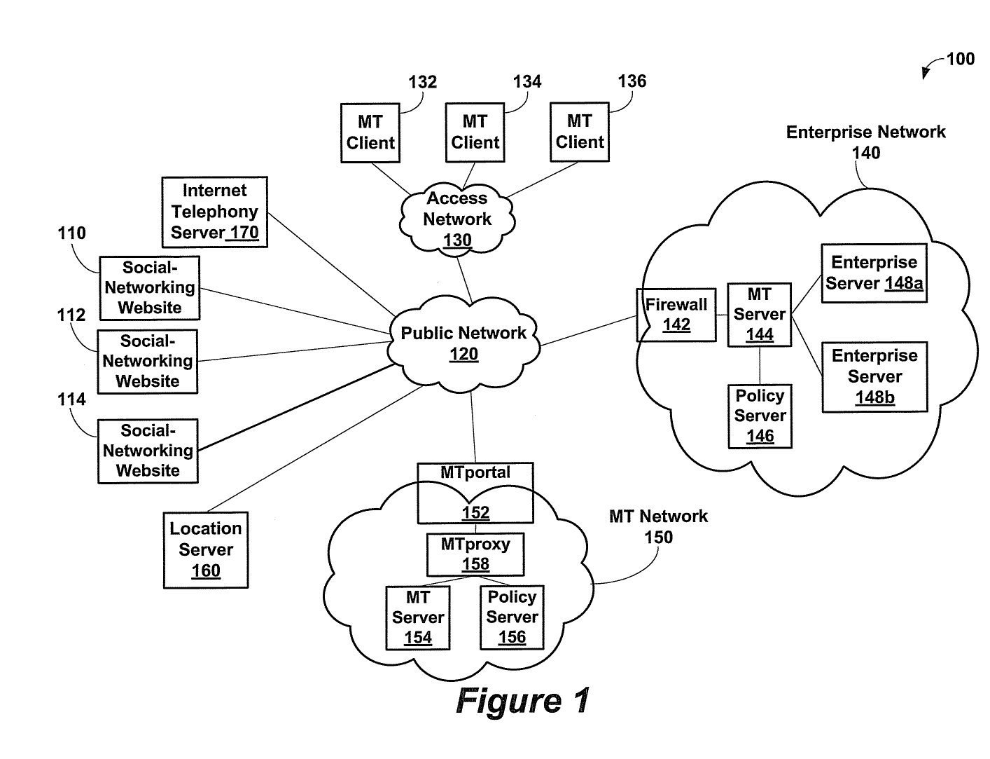

Turning to the figures, FIG. 1 is an example communications network 100, in accordance with embodiments of the invention. It should be understood that this and other arrangements described herein are set forth only as examples. Those skilled in the art will appreciate that other arrangements and elements (e.g., machines, interfaces, functions, orders, and groupings of functions, etc.) can be used instead, and that some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. Various functions may be carried out by a processor executing instructions stored in memory.

As shown in FIG. 1, the example communication network 100 may include one or more social-networking websites 110, 112, and 114 each connected to a public network 120, an access network 130 connecting one or more MTclients 132, 134, and 136 to the public network 120, an enterprise network 140 connected to the public network 120, and an MT network 150 connected to the public network 120, one or more location servers 160, and one or more internet-telephony servers 170. Note that additional entities not depicted in FIG. 1 could be present as well. As an example, there may be more MTclients in communication with the public network 120, additional social-networking websites, location servers, internet-telephony servers, access networks, and/or enterprise networks in communication with public network 120. Further, there may be other data repositories, servers and websites not shown in FIG. 1 in communication with the public network 120

There could be one or more devices and/or networks making up at least part of one or more of the communication links depicted in FIG. 1. As an example, there could be one or more routers, switches, or other devices or networks on the link between the public network 120 and the MTportal 152. Additionally, the herein-described functionalities of the public network 120 and MT Network 150 may be combined into one network.

To carry out these functions, each of the social-networking websites 110-114, MTclients 132-136, firewall 142, MTservers 144 and 154, policy servers 146 and 156, enterprise servers 148a and 148b, MTportal 152, and MTproxy 158, may take the form of a computing/communication device, such as a cell phone, personal digital assistant, wirelessly equipped personal computer, personal computer, application server, computing unit, or other entity now known or later developed configurable to carry out the herein-described functionality of a social-networking website, MTclient, firewall, MTserver, policy server, enterprise server, MTportal, and/or MTproxy.

Public network 120 may be the Internet or may comprise some other public or private packet-switched and/or circuit-switched network. Public network 120 could include any number of gateways, routers, proxies, and other intervening elements and may include one or more of the elements of the access network, enterprise network 140, and/or MT Network 150 described below.

Each MTclient 132, 134, and 136 may likewise take various forms, examples of which include the computing/communication devices listed above, and may each be configured to perform the herein-described functionality of an MTclient. The social-networking websites 110-114, MTclients 132-136, firewall 142, MT servers 144 and 154, policy servers 146 and 156, enterprise servers 148a and 148b, MT servers 144 and 154, MT location server 160, internet telephony server 170, and/or network entity 110 may be further programmed with a plurality of applications, each of which serves a discrete device function that may or may not involve user interaction. Examples of such applications include, without limitation, voice processing, image processing, word processing, phone book, calendar, spreadsheet, games, audio player, video player, web browser, image management, graphics editing, utilities, web-logs (“blogs”), online encyclopedias (“Wikis”), directory services, and other applications now known or later developed. In some embodiments, some or all of MTclients 132, 134, and 136 may have a wireless-communication interface comprising an antenna and a chipset for communicating with one or more access nodes over an air interface, such as but not limited to a GSM, UMTS, 3G, CDMA, TDMA, WiFi, WiMAX, and/or EV-DO air interface(s).

Each of the social-networking websites 110-114 may provide access to application data, such as contact lists, messages, video content, textual content, audio content, binary data, and/or other information. The access may be permitted to users that have subscribed to a given social-networking website 110-114. For example, social-networking website 110 may provide users to subscribe and then permit subscribed users to send and receive e-mail, news, and other information.

FIG. 1 shows the enterprise network 140 with firewall 142, MTserver 144, policy server 144, and enterprise servers 148a and 148b. The firewall 142 may be connected to the public network 120 and protect enterprise network 140 from unauthorized access and electronic attacks/viruses entering via the public network 120. The firewall 142 may also restrict access from within the enterprise network 140 to the public network 120; for example, the firewall 142 may not allow access to certain websites from devices within the enterprise network 140. The MTserver 144 may be connected to the firewall 142, policy server 146 and the enterprise servers 148a and 148b. The MTserver 144 and policy server 146 may perform the functions of the herein-described MTserver and policy server, respectively. Enterprise servers 148a and 148b may permit employees or other persons associated with the enterprise with e-mail to use the applications described above.

The MT Network 150 may include an MTportal 152 connect to the public network 120, an MTproxy 158 connected to the MTportal 152, the MTserver 154 and policy server 156. The MT Network 150 may be a physical network or may be an overlay network.

Note that the herein-described functionality of the MTportal, MTproxy, MTserver, and/or policy server may be combined and performed on one physical device. Similarly, multiple physical devices may be used to perform the herein-described functionality of the MTportal, MTproxy, MTserver, and/or policy server.

The MTportal 152 may provide access to the MTclients 132-136 to the MT Network 150. The MTproxy 158 may receive requests from the MTclients 132-136 and act on their behalf within the MT Network 150 to service the requests. Additionally, the MTproxy 158 may act on behalf of the MTclients 132-136 for handling events and event indications within the MT Network 150. Additionally or instead, the MTproxy 158 may perform the functions of the herein-described MTproxy.

The MTserver 154 and policy server 156 may perform the functions of the herein-described MTserver and policy server, respectively.

Example Scenarios for a PULL Operation

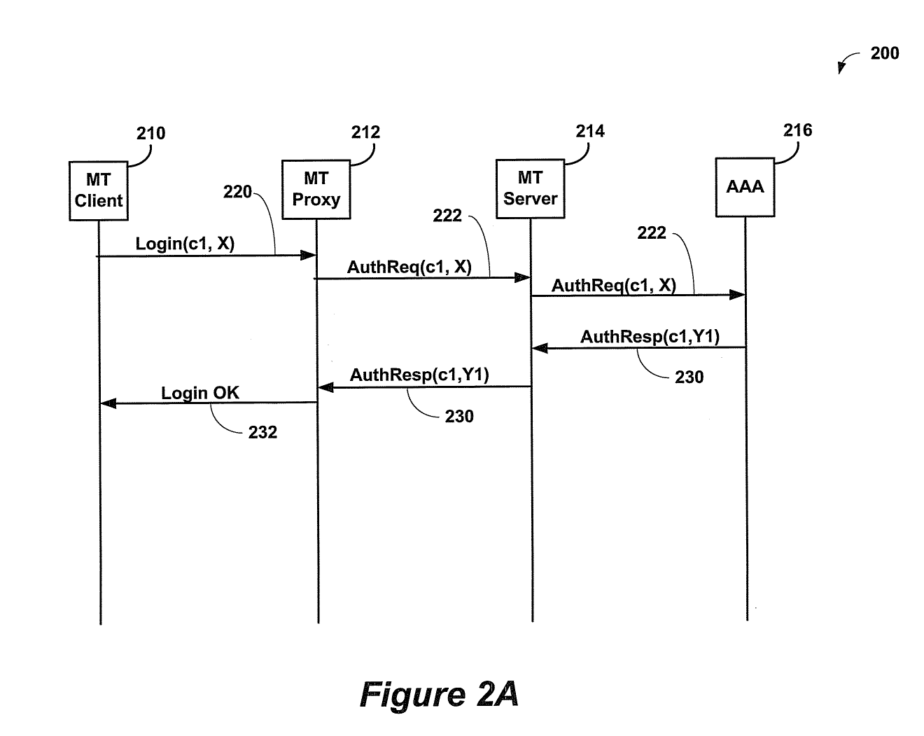

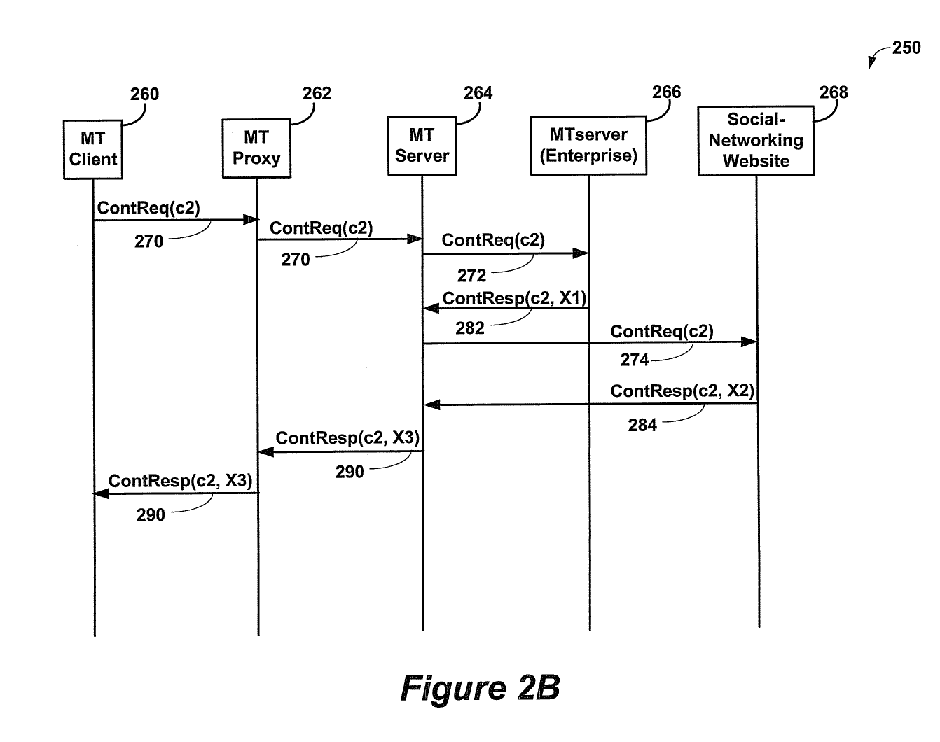

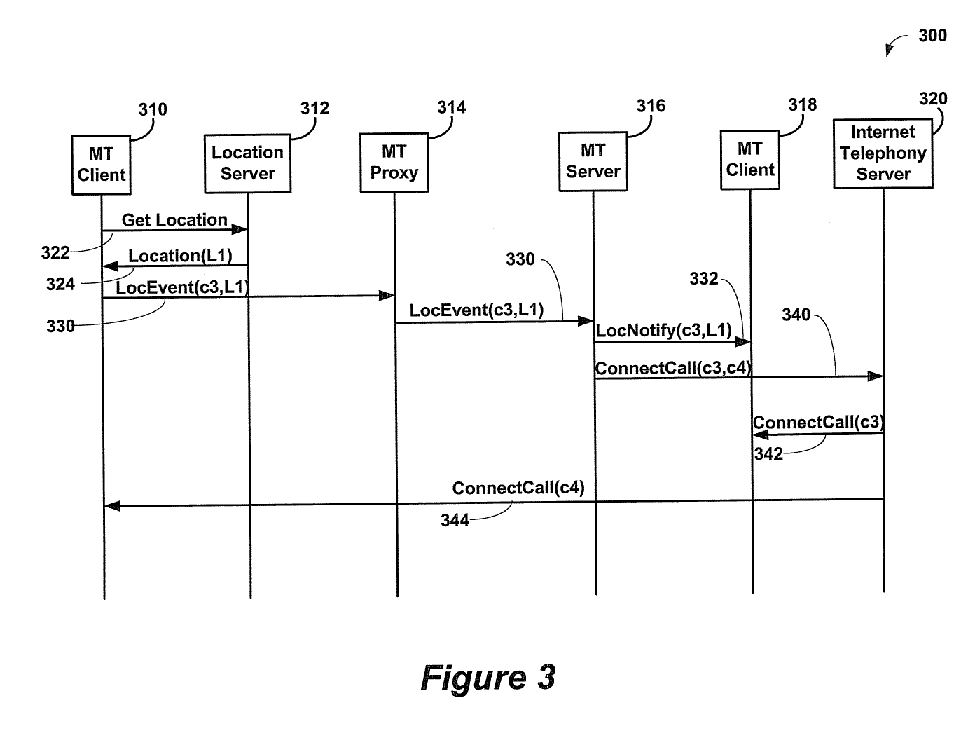

FIG. 2A depicts a scenario 200 of authenticating an MTclient 210, in accordance with embodiments of the invention. Messages, requests, responses, events, event indications, and/or calls shown in scenarios 200, 250, and 300 as depicted in FIGS. 2A, 2B, and 3, respectively, may pass through one or more networks during their transmission. The one or more networks include, but are not limited to, access networks, public data networks, private data networks, wired networks, wireless networks, local area networks (LANs), and wide area networks (WANs).

The MTclient 210 may send a Login message 220 to MTproxy 212. FIG. 2A shows the Login message 220 includes an indication of a contact (or user) name “cl” and authentication information “X”. The authentication information may be a password, authentication key, application key, or other similar data now known or to be discovered that acts to authenticate a contact. In some embodiments, the Login message 220 may not include the contact name c1 and/or the authentication information X.

At the MTproxy 212, an authentication request (“AuthReq”) 222 is generated based on the Login message. The AuthReq 222 may include with the contact name c1 and authentication information X. FIG. 2A shows the AuthReq 222 sent from the MTproxy 212 and received an MTserver 214. The MTserver examines the AuthReq 222 and determines that the AuthReq 222 is to be processed by an Authentication, Authorization, and Accounting server (“AAA”) 216.

After receiving the AuthReq 222, the AAA 216 may verify the authentication information X for the contact name c1. Based on the verification, the AAA 216 may generate an authentication response (“AuthResp”) 230. In this scenario, a successful authentication is assumed; however, other scenarios are possible where the authentication response is unsuccessful. The AuthResp 230 provides an indication of the authenticated contact name c1 and the authentication response Y1. The authentication response Y1 may be null or may include a key or other access information.

FIG. 2A shows that the AAA 216 sends the AuthResp 230 to the MTserver 214, which in turn sends the AuthResp to MTproxy 212, as MTproxy 212 is associated with the contact having contact name c1. Upon reception of the AuthResp 230, MTproxy 212 may generate reformat the AuthResp 230 into a “Login OK” message 232. Once the Login OK message 232 has been generated by the MTproxy 232, FIG. 2A shows the Login OK message 232 sent from the MTproxy 212 to the MTclient 210.

In some embodiments, the Login message 220 and AuthReq 222 are formatted in the same way; therefore, the Login message 220 and the AuthReq 222 may be identical. Similarly, in some embodiments, the AuthResp 230 and the Login OK message 232 may be identical.

Upon receiving the Login OK message 232, the MTclient may be deemed as authorized to access functionality associated with AAA 216. In scenarios described with respect to FIGS. 2B, and 3, any required authentication/authorization is assumed to have been performed prior to a given scenario.

FIG. 2B depicts a scenario 250 of a pull operation by requesting contact information, in accordance with embodiments of the invention. This example scenario shows how parallel processing and scalability are used to combine public and private data in a controlled fashion. The techniques presented herein may be used to aggregate data from any number of sources.

An MTclient 260 formats a contact request (“ContReq”) 270 for a desired contact c2. FIG. 2 shows the MTclient 260 sends the ContReq 270 including the desired contact c2. Note that c2 may indicate more than one contact. Further, the contact c2 may be indicated by various criteria, such as but not limited to name, address, phone number, e-mail address, and/or by reference to a contact list, address book, friends list, or similar data structure. Additionally or instead, c2 may be indicated as one or more queries for information, such as “all contacts within 10 kilometers of the location of MTclient 260”. Thus, c2 may include various criteria to identify contact(s).

The ContReq 270 may be a transaction/request to an MTserver to search in a directory for an individual and related documents and e-mail/SMS addresses. The ContReq 270 may include a request for information about the contact c2 from multiple data sources available on the Internet. ContReq 270 may include criteria to identify the multiple data sources, such as, but not limited to, uniform resource locators (URL), uniform resource indicators (URIs), fully qualified domain names (FQDNs), Internet Protocol (IP) addresses, and/or other data-source-identification information.

A request to an MTserver, such as ContReq 270, may be in the form of a URL. The URL may be part of a REpresentational State Transfer (REST) protocol implemented by an MTserver and/or a protocol related to a REST protocol using HyperText Transfer Protocol (HTTP) GET and/or POST requests.

For example, a URL may be preceded by “http://” and then formatted as follows:
host.mobiletribe.net/ws?Parameters
   The Parameters may be formatted as “&”-separated NAME=VALUE pairs. For example, the following URL is formatted as an HTTP GET request to perform the “GetFriendsList” operation for the “friends” feature:
host.mobiletribe.net/ws?feature=friends&operation=GetFriendsList

Example Parameters include feature, operation, portal, version, application keys, and operation-specific parameters. A feature Parameter may indicate a type of information requested, such as but not limited to an addressbook, alerts, blog, friends, messages, pictures, upload, video, or voice feature. Operation Parameters are specific to features; that is, an operation Parameter describes a request to be performed for the specified feature Parameter. For example, for the messages feature, example operations include DeleteMessage, GetMessage, GetMessageHeaders, and SendMessage. Many other features and operations are possible as well.

The portal Parameter may specify one or more data repositories, such as but not limited to, social-networking websites, enterprise servers/websites, networked computers and databases, and other websites. Example values for the portal Parameter include bliptv, facebook, google, jajah, multimedia, myspace, orb, orkut, plaxo, yahoo, and youtube. Many other values for the portal Parameter are possible as well. Feature, operation, and portal Parameters may be case sensitive; that is, a “message” Parameter may be different than a “Message” parameter due to the case of the letter “m”/“M”. The MTserver may define and/or create a dynamic community based on the request—the dynamic community may include the data sources specified as portal Parameters, a user associate with the MTclient, and any contacts found as part of performing the operation(s) specified in operation Parameters on type(s) of information specified as feature Parameter(s).

The version Parameter may numerically or otherwise specify a version of the feature used to communicate with the MTserver. The application key Parameter may authorize an MTclient to access the MTserver. Additional Parameters may be specified as NAME=VALUE pairs in the URL.

For most requests, a URL with all the parameters sent as a GET method is sufficient. When parameter values are large and/or conform to a structure, an alternative is to use the POST method and move the parameters with long and/or structured values into the POST body. Table 1 below shows an example request using the POST method.

TABLE 1

```
<mt_request>
  <description>
    Twas Brilling and the slithy Towes
    Did Gyre and Gimble in the Vabe.
    All Mamsy were the Borogoves, and the
    Mome rath has Outgrabed....
  </description>
</mt_request>
```

FIG. 2B shows the ContReq 270 sent from the MTclient 260 to MTproxy 262. MTproxy262, acting on behalf of MTclient 260, passes on the ContReq 270 to MTserver 264 as shown in FIG. 2B.

The MTserver 264 may examine the ContReq 270 and subsequently generate and sent one or more sub-requests triggered by the original ContReq 270. For example, the MTserver may review portal and/or other Parameters in the ContReq 270 to determine that multiple sub-requests are needed to satisfy ContReq 270. FIG. 2B shows the MTserver 264 sending two sub-requests: a sub-request ContReq 272 to MTserver (Enterprise) 266 and a sub-request ContReq 274 to social-networking website 268. The MTserver (Enterprise) 266 may be located in an enterprise network, and in particular, may reside behind a firewall of the enterprise network. In this fashion, MTservers may pass on requests to other (peer) MTservers to gain access to private data.

The access provided by peer MTservers may be based on policies stored in a policy server that indicate the enterprise's rules on data access. For example, a contact request sent to an enterprise may or may not permit name, telephone number, e-mail address, physical mail address, title/rank information, and/or other information to be provided to entities and individuals outside of the enterprise based on the policies stored in the policy server. Similar policies may be used by policy servers associated with public MTservers as well. Other policies may be implemented by use of the policy server as well, such as but not limited to, limitations on the number, size, time and cost of messages, pricing or other accounting policies, and/or instructions on accessible types of features, operations, and/or data sources. Many other policies may be implemented by MTserver(s) and/or policy server(s).

FIG. 2B shows the MTserver (Enterprise) 266 sending a Contact Response (“ContResp”) 282 to the ContReq sub-request 272 and shows the social-networking website 268 sending a ContResp 284 to the ContReq sub-request 274. ContResp 282 and ContResp 284 supply contact information X1 and X2, respectively about contact c2. FIG. 2B also shows ContResp 282 and ContResp 284 received at MTserver 264.

Upon reception of ContResp 282 and ContResp 284, MTserver 264 may aggregate the information received from the sub-requests. For example, suppose c1 indicates a “M. Mouse” as a requested contact. Further suppose X1 indicates that M. Mouse works at Disby Co. and has a work number of 555-123-4567 and a work e-mail address of mmouse@disby.com and that X2 indicates that M. Mouse has two e-mail addresses: mmouse@disby.com and mouse1234@cheeselovers.com. In this example, the MTserver 264 may then generate an aggregate data item for the aggregate contact information X3 by first including all unique data and then correlating duplicate data (in this example, the two indications of M. Mouse's work e-mail). Thus, the aggregated contact information may provide unique data aggregated and correlated from multiple data sources—in this example, contact information X3 may include an e-mail address list of mmouse@disby.com and mouse1234@cheeselovers.com and a phone number list of 555-123-4567. Further, the aggregate contact information may indicate a source of information (e.g., mmouse@disby.com (work e-mail) and mouse1234@cheeselovers.com (Cheese Lovers web site)). Many other aggregation techniques are possible as well, such as but not limited to, the use of mash-ups, application programmer interfaces (APIs), and/or screen scraping techniques.

Note that MTserver (Enterprise) 266 may have in turn sub-divided ContReq 272 into sub-subrequests, such as a query for an e-mail address made to an e-mail-directory server or a query for phone information to enterprise directory servers and/or telephone equipment. The MTserver (Enterprise) 266 may then aggregate the retrieved data and apply policy rules to the aggregated and/or unaggregated data, to generate contact information X1 sent in ContResp 282. This process of sub-dividing requests, and aggregating responses may be performed by several MTservers as needed based on a given trigger, such as an information request, command, and/or for event processing.

The MTserver 264 may consult with a policy server configured with policy rules to apply for the use of the collected data, as described above. Policy rules may be applied by both MTserver 264 and MTserver (Enterprise) 266.

FIG. 2B shows the MTserver sending a ContResp 290 to the MTproxy 262. Once the aggregated contact information X3 has been generated, the MTserver 260 may generate a ContResp including the original desired contact c2 and/or the aggregated contact information X3. FIG. 2B shows MTserver 260 sending ContResp 290 with the original desired contact c2 and the aggregated contact information X3 to MTproxy 262. Upon reception of ContResp 290 at the MTproxy 262, ContResp 290 may then be sent to MTclient 260 as shown in FIG. 2B.

An Example Scenario for a PUSH Operation

FIG. 3 depicts a scenario 300 involving a location event, in accordance with embodiments of the invention.

Scenario 300 starts with an “event” or a state change somewhere in the system or a pending social network. As shown in FIG. 3, the event is a location event indication (“LocEvent”) 330. The LocEvent 330 may be generated by an MTclient based on a change of location and/or based on a query to a location server. FIG. 3 shows MTclient 310 querying a location server 312 using a Get Location message 322 and the location server 310 returning a Location message 324 indication for a location L1 to MTclient 310. In other embodiments, the MTclient 310 may determine L1 without sending a Get Location (or similar) message, perhaps by use of a GPS chip, location information provided via other techniques and/or by use of other location device(s) accessible to a communication device acting as MTclient 310.

Event reporting may be in the form of an alarm, exception, or message. For example, MTclient location changes may trigger (if permitted by the MTclient) event notifications to flow from any MTclient to an MTserver.

FIG. 3 shows an example of location event reporting to an MTserver as LocEvent 330 is passed from MTclient 330 to MTserver 316 via MTproxy 314. FIG. 3 shows LocEvent 330 includes the location information L1 discussed above as well as contact information c3 for MTclient 310.

The MTserver 316 may query a policy server before reporting LocEvent 330. The policy server may be consulted to check for policy rules regarding user preferences, such as but not limited to “do not disturb” settings, event notification permissions, and/or device activity status (e.g., powered on and within communication range). An MTclient may be configured with policy rules that allow some or all events to be reported, while denying reporting of some or all events. For example, the MTclient 310 may include policy rules configured to allow reporting of location events and to deny the reporting of message-related events (e.g., sending an e-mail, making a telephone call, receiving an SMS message). Other policy rules may be provided as well, such as policy rules regarding billing account status, payment-related policies, and/or advertising policies. Some or all of these policy rules may be stored in a user profile to permit ready association between a given user and the associated policy rules. The user profile and/or policy rules may be stored on an MTclient, on an MTserver, and/or on a policy server. For example, policy rules regarding do not disturb settings may be stored on an MTclient and payment-related policy rules may be stored on an MTserver, and/or on a policy server.

The use of user-controllable event notification provides the advantage of autonomous operation of event reporting and the ability of other devices to constantly monitor for event indications from one or more MTclients. Further, permitting MTclients and MTservers (in coordination with policy servers) control over event reporting allows flexible application of event-reporting policies at an individual client and/or event level.

MTserver 316 may set, store, update, delete, and examine pre-defined conditions for incoming events. For example, a parent may request notification of a schoolchild's location one hour after school ends to determine the schoolchild is where the parent expects the schoolchild to be. In this case, a dynamic community may be formed that includes an MTclient for the parent and an MTclient for the schoolchild once the schoolchild's MTclient sends a location notification that is received by the parent's MTclient.

A more complex example is monitoring when a “quorum” or predetermine number/percentage of a group of people have arrived at a particular location; e.g., when 50% of meeting attendees have arrived at hotel (or set of hotels) for a meeting at the meeting's start time or when 30 employees or other persons associated with an enterprise (e.g., customers of the enterprise) have arrived at a convention site. As another example, a “meeting may begin” message may be sent when a quorum of meeting participants are within 1000 feet of each other. Such a “meeting may begin” message may be sent to an individual user, all members of the quorum, all meeting invitees, meeting organizers, and/or other people.

Once the appropriate conditions are met then dynamic community formation will occur. Formation of a dynamic community may in turn drive gathering of more information. For example, the formation of a dynamic community (e.g., the quorum condition for a meeting is met) could drive additional information to be gathered (e.g., contact information for all quorum members may be gathered and then distributed to all meeting participants). The dynamic community may include one or more persons involved with the event, such as a person whose location has changed or attendees of a meeting. The additional information may be gathered and aggregated using the techniques described above with respect to FIG. 2B.

Thus, data collection may be triggered in response to state changes in a social network or upon the formation of a dynamic community. Further, the information relevant to the newly formed social community is not requested or provided until the community is instantiated. This late binding of social information both provides the most current information to the dynamic community and enhances scalability, since information requests are not processed until they are needed. Also, multiple communication channels and processors may be used in parallel to gather and provide the late-bound social information, allowing for faster data gathering times and more efficient transmission of the social information.

FIG. 3 shows MTserver 316 sending a location event notification “LocNotify” 332 to MTclient 318. MTserver may generate LocNotify 332 based on settings made by MTclient 318 and/or MTclient 310. That is, MTclient 318 may have set a pre-defined condition to be notified about the location of MTclient 310 and MTclient 310 may have allowed transmission of LocEvent 330 and/or the specific notification to MTclient 318. That is, both MTclients 310 and 318 may select specific MTclients to receive event notification and to monitor for event notifications, respectively. The LocNotify 332 message as shown in FIG. 3 indicates the contact information c3 and the location information L1.

In other scenarios, dynamic community formation could drive any number of activities in support of the group while simultaneously sending all the data/information as described above with respect to FIG. 2B. For example, dynamic community formation based on the notification of MTclient 318 of the location of 318 may trigger setup of a telephone call number via an internet (or other) telephony server.

FIG. 3 shows the establishment of a call in response to LocEvent 330. In the scenario shown in FIG. 3, MTserver 310 has previously been instructed to set up a telephone call between MTclients 310 and 318 in response to location events from MTclient 310. For example, the Loc Event 330 may include a location L1 that MTclient 310 is at a specific place (e.g., an airport) or within (our outside of) a predetermined distance of MTclient 318. Based on the location L1, the MTserver 310 may send a ConnectCall request 340 to internet telephony server 320. The ConnectCall request 320 may be interpreted by the internet telephony server 320 as request to set up a telephone call to connect parties with contact information c3 (for MTclient 310) and c4 (for MTclient 318). The internet telephony server may use existing telephony messages to connect MTclient 318 and MTclient 310. FIG. 3 shows example ConnectCall messages 342 and 344 to illustrate possible messages sent from the internet telephony server 320 to the MTclients 318 and 310, respectively, to set up the requested telephone call.

An Example Computing Device

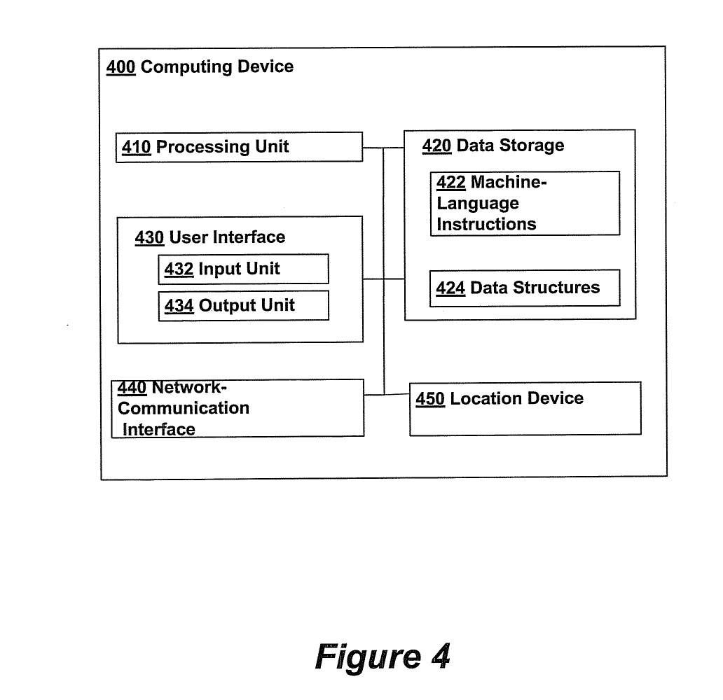

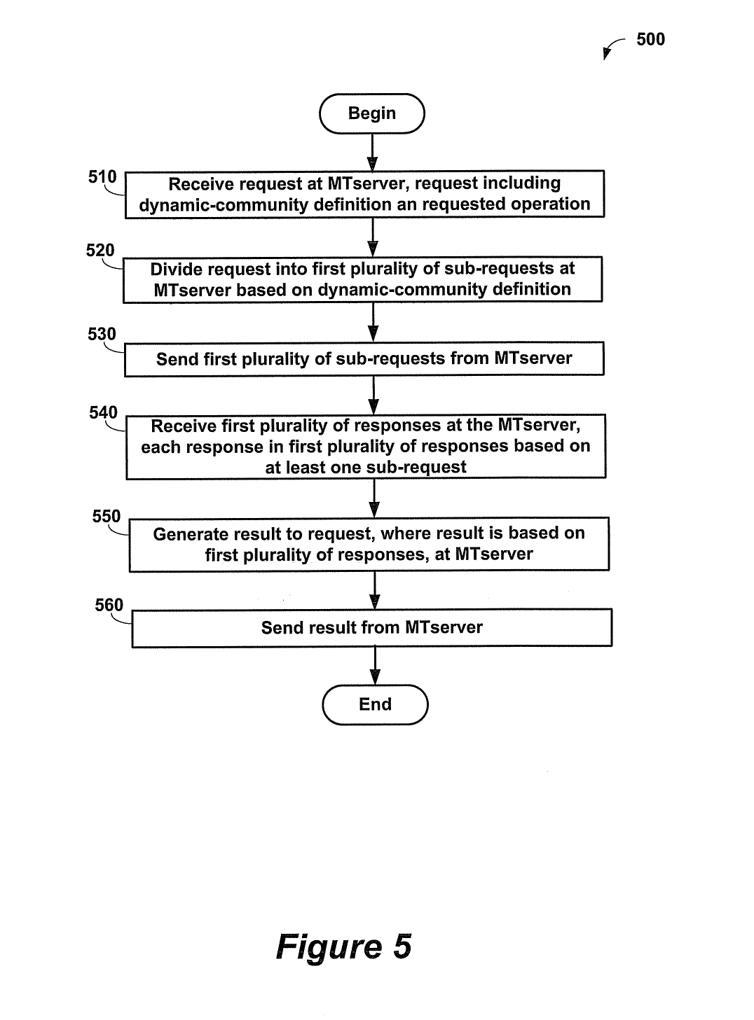

FIG. 4 is a block diagram of an example computing device 400, comprising a processing unit 410, data storage 420, a user interface 430, and a network-communication interface 440, in accordance with embodiments of the invention. A computing device 400 may be a desktop computer, laptop or notebook computer, personal data assistant (PDA), mobile phone, embedded processor, or any similar device that is equipped with a processing unit capable of executing computer instructions to perform at least part of any or all of the herein-described methods and scenarios, scenarios depicted in FIGS. 2A, 2B, and 3, methods depicted in FIGS. 5, 6, and 7 and/or herein-described functionality of an MTserver, MTclient, MTportal, MTproxy, policy server, social-networking website, location server, internet telephony server, access network, public network, firewall and/or enterprise server.

The processing unit 410 may include one or more central processing units, computer processors, mobile processors, digital signal processors (DSPs), application-specific integrated circuits (ASICs), graphics processing units (GPUs), microprocessors, computer chips, integrated circuits, and similar processing units now known and later developed and may execute machine-language instructions and process data.

The data storage 420 may comprise one or more storage devices. The data storage 420 may include read-only memory (ROM), random access memory (RAM), removable-disk-drive memory, hard-disk memory, magnetic-tape memory, flash memory, and similar storage devices now known and later developed. The data storage 420 may be removable and/or dedicated. As such, the data storage 420 may include one or more tangible computer-related media configured to store some or all of the machine language instructions described herein. The data storage 420 comprises at least enough storage capacity to contain machine-language instructions 422 and data structures 424.

The machine-language instructions 422 and the data structures 424 contained in the data storage 420 include instructions executable by the processing unit 410 and any storage required, respectively, at least part of any or all of the herein-described methods and scenarios, scenarios depicted in FIGS. 2A, 2B, and 3, methods depicted in FIGS. 5, 6, and 7 and/or herein-described functionality of an MTserver, MTclient, MTportal, MTproxy, policy server, social-networking website, location server, internet telephony server, access network, public network, firewall and/or enterprise server.

The user interface 430 may comprise an input unit 432 and/or an output unit 434. The input unit 432 may receive user input from a user of the computing device 400. The input unit 432 may comprise a keyboard, a keypad, a touch screen, a computer mouse, a track ball, a joystick, and/or other similar devices, now known or later developed, capable of receiving user input from a user of the computing device 400.

The output unit 434 may provide output to a user of the computing device 400. The output unit 434 may comprise a visible output device, such as one or more cathode ray tubes (CRT), liquid crystal displays (LCD), light emitting diodes (LEDs), displays using digital light processing (DLP) technology, printers, light bulbs, and/or other similar devices, now known or later developed, capable of displaying graphical, textual, and/or numerical information to a user of computing device 400. The output unit 434 may alternately or additionally comprise one or more aural output devices, such as a speaker, speaker jack, audio output port, audio output device, earphones, and/or other similar devices, now known or later developed, capable of conveying sound and/or audible information to a user of computing device 400.

The network-communication interface 440 is configured to send and receive data and may include a wired-communication interface and/or a wireless-communication interface. The wired-communication interface, if present, may comprise a wire, cable, fiber-optic link or similar physical connection to a wide area network (WAN), a local area network (LAN), one or more public data networks, such as the Internet, one or more private data networks, or any combination of such networks. The wireless-communication interface, if present, may utilize an air interface, such as an IEEE 802.11 (e.g., Wi-Fi) and/or IEEE 802.16 (e.g., WiMax) interface to a WAN, a LAN, one or more public data networks (e.g., the Internet), one or more private data networks, or any combination of public and private data networks.

The computing device 400 may also comprise a location device 450. The location device 450 may utilize one or more technologies and techniques to determine a current position, including but not limited to Global Positioning System (GPS), gyroscopes, dead reckoning techniques, magnetic devices such as compasses, landmark comparison processes, lasers (including range finders and ring gyroscopes), and/or radio-frequency waves. Other techniques and technologies for determining the current position of the location device are possible as well. The location device 450 may report the determined current position to the processing unit 410 and/or store the current position in the data storage 420.

An Example Method for PULL Operations

FIG. 5 is a flowchart depicting an example method 500, in accordance with embodiments of the invention. Method 500 may describe processing of PULL operations, such as commands or requests for information.

It should be understood that each block in this flowchart and within other flowcharts presented herein may represent a module, segment, or portion of computer program code, which includes one or more executable instructions for implementing specific logical functions or steps in the process. Alternate implementations are included within the scope of the example embodiments in which functions may be executed out of order from that shown or discussed, including substantially concurrently or in reverse order, depending on the functionality involved, as would be understood by those reasonably skilled in the art of the described embodiments.

Method 500 begins at block 510. At block 510, an MTserver may receive a request. The request may include a dynamic-community definition and requested operation. The dynamic-community definition may include one or more contacts associated with the request and/or one or more data sources. The contacts may include a contact making the request and one or more other contacts. The data sources may include one or more social-networking websites, enterprise servers, MTservers, and/or other data sources. The requested operation may be specified as a feature/operation pair, for example an operation to be performed on a feature indicating a type of information requested.

The request may be sent directly to the MTserver by a requestor, or the result may travel through MTproxies and/or other entities (e.g., networks, firewalls, etc) before being received by the MTserver.

In particular, the requester may be an MTclient and/or the request may be formatted as a URL, such as described above with respect to FIG. 2B.

At block 520, an MTserver may divide the request into a first plurality of sub-requests based on the dynamic-community formation. For example, if a plurality of data sources are specified in the request, one sub-request may be generated for each unique data source in the plurality of data sources. In some cases, multiple sub-requests may be sent to a single data source; for example, a request to find a contact at a social-networking website SN1 and then send a message via DS1 to the contact, may involve two sub-requests to SN1: a query for the contact at SN1 and a subsequent request to SN1 to send the message based on the retrieved contact information.

At block 530, the MTserver may send the first plurality of sub-requests. Each sub-request may be sent to one or more data sources identified in the request. The sub-request may be sent as described above with respect to FIG. 2A.

At block 540, the MTserver may receive a first plurality of responses to the first plurality of sub-requests. Each response may be based on at least one sub-request. In some scenarios, a data source may provide one response to multiple sub-requests: for example, if social-networking website SN2 receives two sub-requests for contact information, SN2 may provide one response satisfying both sub-requests (e.g., as a list of contacts including the data sought in both sub-requests of this example).

At block 550, the MTserver may generate a result to the request. The result may be based on the first plurality of responses. To generate the result, the MTserver may any or all of the herein-described aggregation techniques, such as but not limited to the aggregation techniques described above with respect to FIG. 2B.

Note that this technique of sub-dividing a request, sending the sub-divided requests to one or more data sources and generating results based on aggregating the responses to the sub-requests is not limited to one MTserver. For example, one or more sub-requests may be sent from a first MTserver to a second MTserver. The second MTserver may in turn divide the received sub-request into a second plurality of sub-requests. The second MTserver may receive a second plurality of responses, each based on at least one of the second plurality of sub-requests. Then, the second MTserver may generate a response to the sub-request at the second MTserver based on the second plurality of sub-requests. Once the response to the sub-request is generated, the second MTserver may send the response to the sub-request to the first MTserver. The first MTserver may in turn aggregate the aggregated response to the sub-request received from the second MTserver (and so on).

The response may be generated by merging each response in the first plurality of received responses into an initial result and then correlating and/or filtering the initial result to generate the result. Correlating and/or filtering the initial result may include removing duplicate data items from the initial result.

At block 560, the MTserver may send the result. The result may be sent directly to the requestor, or the result may travel through MTproxies and/or other entities before being received by the requestor.

After performing the techniques of block 560, method 500 may end.

An Example Method for PUSH Operations

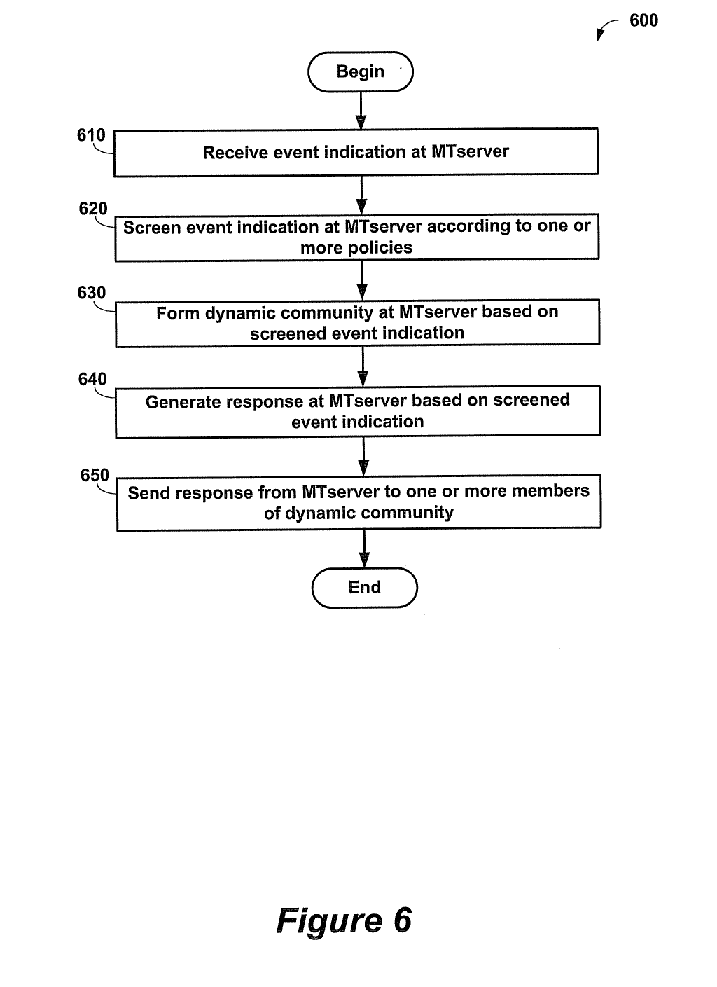

FIG. 6 is a flowchart depicting an example method 600, in accordance with embodiments of the invention. Method 600 may describe processing of PUSH operations, such as events or event notifications.

Method 600 may begin at block 610. At block 610, an MTserver may receive an event indication. Example event indications may be related to a message or a change of location, but many other event indications are possible as well. The event indication may be as described above, particularly as described with respect to FIG. 3.

At block 620, the MTserver may screen the event indication according to one or more policies. The policies may be stored as policy rules. The MTserver may communicate with one or more policy servers to determine the policies. Also, an MTclient associated with the event may be configured to allow reporting of some or all event, while denying reporting of some or all events. The policies, configuration, and associated screening may be as described with respect to FIG. 3.

At block 630, the MTserver may form a dynamic community based on the screened event indication. The dynamic community may include one or more persons involved with the event, such as attendees of a meeting. In particular, the dynamic community may be formed as described above with respect to FIG. 3.

At block 640, the MTserver may generate a response based on the screened event indication. The response may be an event notification, information related to the event, a telephone call set up in response to the event, such as described above with respect to FIG. 3.

At block 650, the MTserver may send the response at the MTserver to one or more members of the dynamic community, such as described above with respect to FIG. 3.

After performing the techniques of block 650, method 600 may end.

An Example Method for Processing Triggers

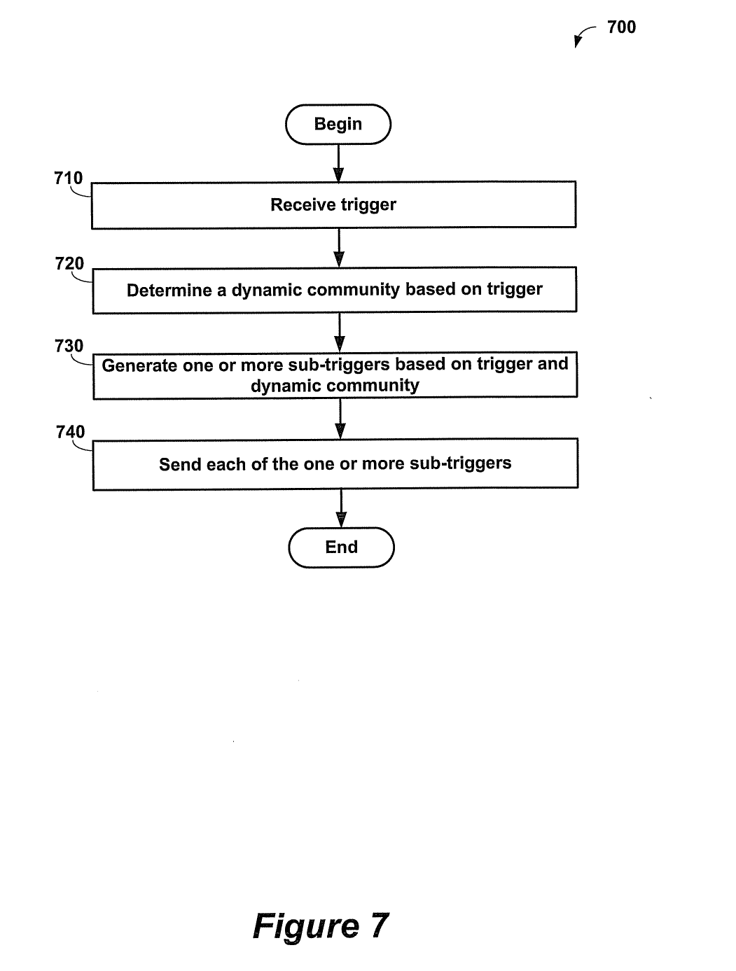

FIG. 7 is a flowchart depicting an example method 700, in accordance with embodiments of the invention. Method 700 may describe processing of triggers

Method 700 may begin at block 710. At block 710, a trigger is received. The trigger may be an event notification, command, a request for information, such as a request for information including a dynamic-community definition and a requested operation., or other electronic message, such as described above with respect to FIGS. 1, 2B, 3, 5, and 6.

At block 720, a dynamic community based on the trigger is determined, such as described above with respect to FIGS. 1, 2B, 3, 5, and 6.

At block 730, one or more sub-triggers based on the trigger and the dynamic community are generated. The sub-triggers may be sub-requests to the request for information, event notifications, and/or other messages generated as described above with respect to FIGS. 1, 2B, 3, 5, and 6.

At block 740, one or more sub-triggers are sent as described above with respect to FIGS. 1, 2B, 3, 5, and 6.

As indicated above at least with respect to FIG. 4, the techniques of methods 500, 600, and/or 700 may performed using an apparatus; e.g., a herein-described computing device. In particular, the apparatus performing the techniques of methods 500, 600, and/or 700 may be configured to operate with multiple distributed processors (perhaps arranged in and communicatively coupled into a communication network such as described above with respect to FIG. 1) for parallel data collection and correlation in a scalable fashion. After completing the procedures of block 740, method 700 may end.

Exemplary embodiments of the present invention have been described above. Those skilled in the art will understand, however, that changes and modifications may be made to the embodiments described without departing from the true scope and spirit of the present invention, which is defined by the claims. It should be understood, however, that this and other arrangements described in detail herein are provided for purposes of example only and that the invention encompasses all modifications and enhancements within the scope and spirit of the following claims. As such, those skilled in the art will appreciate that other arrangements and other elements (e.g. machines, interfaces, functions, orders, and groupings of functions, etc.) can be used instead, and some elements may be omitted altogether.

Further, many of the elements described herein are functional entities that may be implemented as discrete or distributed components or in conjunction with other components, in any suitable combination and location, and as any suitable combination of hardware, firmware, and/or software.

We claim:

1. A method, comprising:
receiving a request at an MTserver, wherein the request comprises a dynamic-community definition and a requested operation;
dividing the request into a first plurality of sub-requests at the MTserver based on the dynamic-community definition;
sending each of the first plurality of sub-requests from the MTserver;
receiving a first plurality of responses at the MTserver, wherein each response in the first plurality of responses is based on at least one of the first plurality of sub-requests;
generating a result to the request at the MTserver, wherein the result is based on the first plurality of received responses; and
sending the result from the MTserver.

2. The method of claim 1, wherein generating the result comprises:
merging each response in the first plurality of received responses into an initial result; and
generating the result based on correlating the initial result.

3. The method of claim 1, wherein the initial result comprises a plurality of contacts and wherein correlating the initial result comprises removing duplicate data items from the initial result.

4. The method of claim 1, wherein the initial result comprises a plurality of contacts and wherein generating the result comprises generating an aggregate data item representing aggregate contact information for the plurality of contacts.

5. The method of claim 4, wherein the aggregate data item comprises at least one indication of a data source.

6. The method of claim 1, wherein sending each of the first plurality of sub-requests comprises:
sending a sub-request to a second MTserver,
dividing the sub-request at the second MTserver into a second plurality of sub-requests,
receiving a second plurality of responses at the second MTserver, wherein each response in the second plurality of responses is based on at least one of the second plurality of sub-requests, and
generating a response to the sub-request at the second MTserver based on the second plurality of sub-requests, and
sending the response to the sub-request from the second MTserver, and
wherein receiving the first plurality of responses at the first MT server comprises receiving the response to the sub-request sent from the second MTserver at the first MTserver.

7. The method of claim 1, wherein generating the result comprises:
generating an initial result by merging the response to the sub-request from the second MTserver with the other responses in the first plurality of received responses, by correlating and/or filtering the initial result, or by both merging the response to the sub-request from the second MTserver with the other responses in the first plurality of received responses and correlating and/or filtering the initial result.

8. The method of claim 1, wherein the dynamic-community definition comprises a portal reference.

9. The method of claim 1, wherein the requested operation further comprises a feature.

10. The method of claim 1, wherein the requested operation comprises determining a list of contacts based on the dynamic-community definition.

11. The method of claim 1, wherein the request is formatted as a uniform resource locator (URL).

12. A method, comprising:
receiving a event indication at an MTserver;
screening the event indication at the MTserver according to one or more policies;
forming a dynamic community at the MTserver based on the screened event indication;
generating a response at the MTserver based on the screened event indication; and
sending the response at the MTserver to one or more members of the dynamic community.

13. The method of claim 12, wherein the event indication is related to a change of location.

14. The method of claim 12, wherein the event indication is related to a message.

15. The method of claim 12, wherein the one or more policies comprises a payment-related policy.

16. The method of claim 12, wherein the one or more policies is a do-not-disturb policy set by a user and stored in a user profile.

17. An apparatus, comprising:
a processing unit;
data storage; and
machine-language instructions, stored in the data storage, executable by the processing unit to perform functions, the functions comprising:
receiving a trigger,
determining a dynamic community based on the trigger,
generating one or more sub-triggers based on the trigger and the dynamic community, and
sending each of the one or more sub-triggers.

18. The apparatus of claim 17, wherein the trigger is an event indication, and each of the one or more sub-triggers is an event notification.

19. The apparatus of claim 17, wherein the trigger is a request comprising a dynamic-community definition and a requested operation, wherein determining the dynamic community comprises determining the dynamic community based on the dynamic-community definition, and wherein each of the one or more sub-triggers is a sub-request.

20. The apparatus of claim 17, wherein the apparatus is configured to operate with multiple distributed processors for parallel data collection and correlation in a scalable fashion.
